(19) United States
(12) Patent Application Publication
(10) Pub. No.: US 2010/0142735 A1
(43) Pub. Date: Jun. 10, 2010

(54) AUDIO APPARATUS AND SIGNAL CALIBRATION METHOD THEREOF

(75) Inventors: Eung-sik YOON, Suwon-si (KR); Sung-han LEE, Suwon-si (KR); Yong-jin KANG, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/552,498

(22) Filed: Sep. 2, 2009

(30) Foreign Application Priority Data
Dec. 10, 2008 (KR) 2008-125476

(51) Int. Cl. H04R 5/02; H04B 7/00; G06F 17/00

(52) U.S. Cl. 381/303; 455/41.3; 700/94

(57) ABSTRACT

An audio system to calibrate an audio signal based on a wirelessly received signal, and a signal calibration method are provided. The audio system includes a sound output unit to output a sound corresponding to a received audio signal. A transceiver is connected to an external device to enable wireless communication between a main unit and the external device. The external device converts the sound output from the sound output unit into an electric signal to generate a calibration audio signal. The main unit performs calibration on an audio signal to be played back through the sound output unit using the calibration audio signal.

### CROSS-REFERENCE TO RELATED APPLICATIONS

This application claims priority under 35 U.S.C. §119(a) from Korean Patent Application No. 10-2008-0125476, filed on Dec. 10, 2008, in the Korean Intellectual Property Office, the disclosure of which is incorporated herein by reference in its entirety.

### BACKGROUND

1. Field of the Invention

The present general inventive concept relates to an audio apparatus, an audio system and a signal calibration method. More particularly, the present general inventive concept relates to an audio apparatus, an audio system and a signal calibration method to calibrate an audio signal based on a wirelessly received signal.

2. Description of the Related Art

As multimedia technologies develop rapidly, it has become possible for home users to view high resolution images on display apparatuses with large size screens and to listen to sound having rich and powerful sound sources through speakers, using various multimedia resources such as high definition televisions (HDTVs) or digital versatile discs (DVDs).

Home theater systems provide high resolution images and powerful sound. Home theater systems typically employ 5.1 channel sound systems. In a 5.1 channel sound system, sound is collected and recorded for each channel, so sound effects are very clear when sound is played back. Additionally, the 5.1 channel sound system includes an additional channel for a low-frequency sound, and the low-frequency sound is played back through a subwoofer, so presence of sound sources is maximized. Accordingly, the 5.1 channel sound system is distinct from a conventional stereo system or a 4 channel sound system.

The 5.1 channel sound system generally includes a main body by which a digital theater system (DTS) and Dolby system are supported, and a plurality of 5.1 channel speakers. The plurality of 5.1 channel speakers may include a left front speaker, a right front speaker, a center speaker, a left rear speaker, a right rear speaker, and a subwoofer.

To listen to 5.1 channel sounds having rich and powerful sound sources, each of the speakers needs to be arranged in an appropriate position around a listener.

However, when the position of the speakers changes, the listener must fix a wire microphone at a position where he or she desires to listen to sound to recalibrate the audio. The sound unit receives audio signals output from each speaker through the wire microphone and calibrates the received audio signals to provide the listener with the optimum sound.

Accordingly, the listener needs to buy a wire microphone when buying an audio apparatus, incurring additional costs. Additionally, to calibrate audio signals, the listener needs to connect the audio apparatus to the wire microphone, fix the microphone in a desired position, and perform other operations for signal calibration, thereby causing inconveniences to the listener.

### SUMMARY

The present general inventive concept provides an audio apparatus to perform calibration on an audio signal based on a signal received wirelessly via a Bluetooth module, and a signal calibration method of the audio apparatus.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an audio apparatus including a sound output unit to output a sound corresponding to a received audio signal; a transceiver connected to an external apparatus, by which the sound output from the sound output unit is converted into an electric signal to generate an audio signal for calibration, to enable wireless communication between the audio apparatus and the external apparatus; and a controller to perform calibration on an audio signal to be played back through the sound output unit, the controller using the calibration audio signal received via the transceiver from the external apparatus for calibration.

The controller may transfer a test audio signal to the sound output unit and control the sound output unit to output a sound corresponding to the test audio signal. The external apparatus may convert the sound, which corresponds to the test audio signal and is output from the sound output unit, into an electric signal to generate the calibration audio signal.

The external apparatus may include a portable apparatus with a microphone to receive the sound corresponding to the test audio signal. The external apparatus may include at least one of a notebook computer, an MPEG audio layer-3 (MP3) player, a mobile phone, a digital multimedia broadcasting (DMB) phone, a digital camera, and a camcorder.

The audio apparatus may further include an audio transfer unit to transfer a plurality of test audio signals. The controller may control the audio transfer unit to transfer a plurality of test audio signals corresponding to a plurality of frequency signals in a preset frequency band to the sound output unit during a preset time period.

The controller may control the audio transfer unit to continue to transfer the plurality of test audio signals to the sound output unit during the preset time period so that the plurality of frequency signals may not overlap.

The sound output unit may include a plurality of speakers. The preset time period may be set so that it sounds to a listener as though a plurality of sounds corresponding to the plurality of test audio signals are output through the plurality of speakers at the same time.

The controller may control the audio transfer unit to transfer each of the plurality of test audio signals to each of the plurality of speakers while sweeping through the frequency band.

The frequency band may be preset to be in the range of about 200 Hz to 20 KHz. The controller may control the audio transfer unit to transfer each of the plurality of test audio signals to each of the plurality of speakers while sweeping through the frequency band.

The controller may display a calibration completion message on an external display apparatus stating that calibration of the audio signal to be played back is completed when calibration of the audio signal to be played back through the sound output unit is completed using the calibration audio signal.

The controller may calibrate at least one of a phase, a time interval, and a signal level of the audio signal to be played back based on the calibration audio signal, and may control the sound output unit to output a sound corresponding to the audio signal of which at least one of the phase, the time interval, and the signal level is calibrated.

A portable device to receive a sound and wirelessly output a calibration signal may comprise: a microphone to receive a sound; a signal processor to process a calibration signal from the microphone corresponding to the sound; and a transceiver to wirelessly transmit the calibration audio signal. The transceiver may be externally connected to the portable device.

The portable device may comprise a manipulator to receive user input and a display to display data received via the transceiver. The portable device may further comprise memory to store data from at least one of the microphone, the manipulator, and the signal processor; a function unit to control non-calibration functions of the portable device; and a controller to control at least one of the microphone, signal processor, transceiver, manipulator, display, memory, and function unit.

A main unit of an audio system may comprise a controller to receive a first audio signal and to receive a calibration audio signal corresponding to a sound produced using the first audio signal, the controller to calibrate a second audio signal using the calibration audio signal; a transceiver to wirelessly receive the calibration audio signal; and terminals to output the first audio signal and the calibrated audio signal. The transceiver may be a Bluetooth-capable transceiver

The main unit may further comprise a recording medium receiver to receive a recording medium and output at least one of the first and second audio signals; an audio processor to receive the first and second audio signals and the calibration audio signals, to process the signals, and to output the processed signals to the controller; and an audio transfer unit to receive the processed first, second, and calibrated audio signals from the controller and to output respective first, second, and calibrated audio output signals to the terminals.

The first, second, and calibration audio signals may be compressed audio signals, and the audio processor may decompress the first, second, and calibration audio signals.

The main unit may further comprise a display for displaying data in response to at least one of receiving the first audio signal, receiving the calibration audio signal, and outputting the calibrated audio signal.

An audio system may comprise the main unit and the portable device, or portable calibration device, to receive a sound resulting from the first audio signal of the main unit. The main unit may comprise the controller to receive a first audio signal and to receive a calibration audio signal from the portable device, the calibration audio signal corresponding to a sound produced using the first audio signal, the controller to calibrate a second audio signal using the calibration audio signal; a first transceiver to wirelessly receive the calibration audio signal from the portable device; and terminals to output the first audio signal and the calibrated audio signal. The portable calibration device may comprise: a microphone to receive a sound corresponding to the first audio signal from the main unit; a signal processor to process a calibration audio signal from the microphone corresponding to the sound; and a second transceiver to wirelessly transmit the calibration audio signal to the main unit.

An audio signal calibration method for a portable calibration device may comprise: wirelessly outputting a connection request; receiving a connection acknowledgement; receiving a test sound via a microphone; converting the test sound into a calibration audio signal; and wirelessly outputting the calibration audio signal.

Receiving a test sound, converting the test sound into a calibration audio signal, and wirelessly outputting the calibration audio signal may be repeated until a termination signal is wirelessly received. A disconnect message may be wirelessly transmitted after outputting the calibration audio signal.

The calibration audio signal may be digitally compressed before wirelessly outputting the calibration audio signal.

The calibration audio signal may be wirelessly output via a Bluetooth module.

An audio signal calibration method for a main unit of an audio system may comprise: wirelessly receiving a transmission request from an external device; wirelessly transmitting a transmission acknowledgement; outputting a first audio signal; receiving a calibration audio signal corresponding to a sound generated from the first audio signal; calibrating a second audio signal using the calibration audio signal to generate a calibrated audio signal; and outputting the calibrated audio signal corresponding to the second audio signal.

The first audio signal and the calibration audio signal may be decompressed by the main unit, and the transmission request and the calibration audio signal may be received via a Bluetooth module.

The first audio signal may be received from a recording medium, and the recording medium may be one of a DVD, a cassette, a compact disk, a floppy disk, and a hard drive.

An audio signal calibration method may comprise: transmitting a first audio signal from a main unit to a sound output device; receiving a first sound corresponding to the first audio signal with an external device comprising a microphone, the external device not being connected to the main unit via wires; converting the first sound into a calibration audio signal with the external device; wirelessly transmitting the calibration audio signal from the external device to the main unit; generating a calibrated audio signal with the main unit using the calibration audio signal; and outputting the calibrated audio signal to the sound output device.

The audio signal calibration method may further comprise wirelessly transmitting calibration data from the main unit to the external device and displaying the calibration data on the external device.

The audio signal calibration method may further comprise displaying calibration data on a display connected to the main unit.

The audio signal calibration method may further comprise: digitally compressing the calibration audio signal with the external device; and digitally decompressing the calibration audio signal with the main unit.

The foregoing and/or other aspects and utilities of the general inventive concept may be achieved by providing a signal calibration method including wirelessly receiving an audio signal for calibration generated by converting an output sound into an electric signal; and performing calibration on an audio signal to be played back using the received calibration audio signal.

The signal calibration method may further include outputting a plurality of sounds corresponding to a plurality of test audio signals. The wirelessly receiving of the calibration audio signal may include wirelessly receiving a calibration audio signal generated by converting the plurality of sounds corresponding to the plurality of test audio signals into a plurality of electric signals.

The plurality of test audio signals may correspond to a plurality of frequency signals in a preset frequency band during a preset time period. The outputting of the plurality of sounds may include outputting a plurality of sounds corresponding to the plurality of test audio signals.

The outputting of the plurality of sounds may include continuously outputting the plurality of test audio signals during the preset time period so that the plurality of frequency signals do not overlap. The preset time period may be set so that it sounds to a listener as though the plurality of sounds corresponding to the plurality of test audio signals are output from a plurality of channels at the same time.

The outputting of the plurality of sounds may include outputting the plurality of sounds corresponding to the plurality of test audio signals to each of the plurality of channels while sweeping through the frequency band. The frequency band may be preset to be in the range of about 200 Hz to 20 KHz.

The outputting of the plurality of sounds may include outputting the plurality of sounds corresponding to the plurality of test audio signals to each of the plurality of channels while sweeping through the frequency band.

Calibration may include displaying a calibration completion message on an external display apparatus stating that calibration of the audio signal to be played back is completed when calibration of the audio signal to be played back is completed using the calibration audio signal.

Calibration may include calibrating at least one of a phase, a time interval, and a signal level of the audio signal to be played back based on the audio signal for calibration.

### BRIEF DESCRIPTION OF THE DRAWINGS

Embodiments of the present general inventive concept will become apparent and more readily appreciated from the following description of the embodiments, taken in conjunction with the accompanying drawings of which:

FIG. 1 illustrates an audio system according to an exemplary embodiment of the present general inventive concept;

FIG. 2 illustrates a block diagram of a main body of the audio system illustrated in FIG. 1 according to an exemplary embodiment of the present general inventive concept;

FIG. 3 illustrates a flowchart explaining an operating method of an audio system according to an exemplary embodiment of the present general inventive concept;

FIG. 4 illustrates a portable calibration device;

FIG. 5 illustrates a flowchart explaining operation of a main unit of the audio system; and

FIG. 6 illustrates a flowchart explaining operation of the portable calibration unit of the audio system.

### DETAILED DESCRIPTION OF THE EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

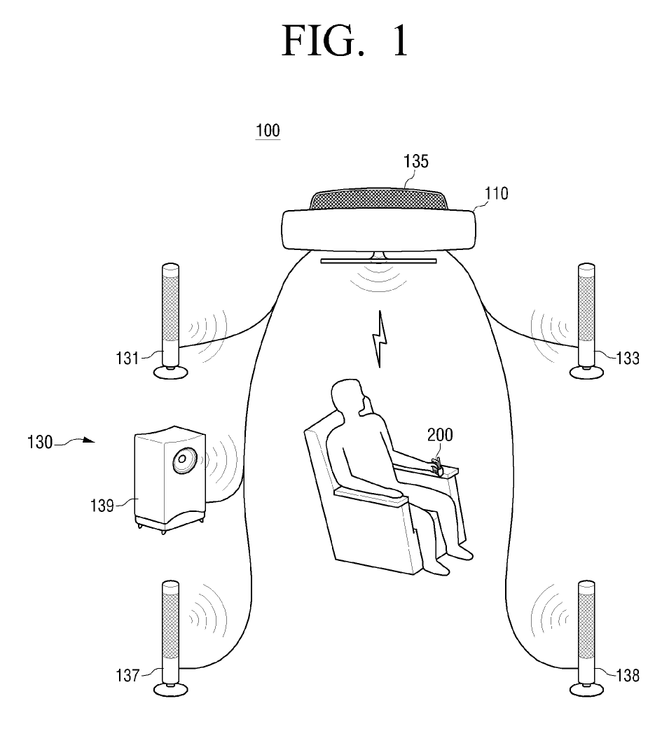

FIG. 1 illustrates an audio system 100 according to an exemplary embodiment of the present general inventive concept.

The audio system 100 of FIG. 1 provides a broadcast program received from a broadcast station or service provider and multimedia stored in a built-in recording medium so that a user can listen to sounds provided by the broadcast program and multimedia. The broadcast station or service provider may provide the broadcast program through either a wired or wireless communication.

As illustrated in FIG. 1, the audio system 100 includes a main body, or main unit, 110 and a sound output unit 130. The main body 110 includes elements to control the overall operations of the audio system 100. The sound output unit 130 may include a left front speaker 131, a right front speaker 133, a center speaker 135, a left rear speaker 137, a right rear speaker 138, and a subwoofer 139.

The main body 110 may be connected via at least one wire to the sound output unit 130, and may output audio signals to the sound output unit 130. It is possible that the main body 110 and the sound output unit 130 may have wireless communication elements to transmit and receive signals corresponding to sound to be reproduced from the speakers.

The main body 110 transmits an audio signal of a left front channel and an audio signal of a right front channel to the left front speaker 131 and the right front speaker 133, respectively.

Likewise, the main body 110 transmits an audio signal of a center channel, an audio signal of a left rear channel, an audio signal of a right rear channel, and an audio signal of a subwoofer channel to the center speaker 135, the left rear speaker 137, the right rear speaker 138, and the subwoofer 139, respectively.

Accordingly, the left front speaker 131, the right front speaker 133, the center speaker 135, the left rear speaker 137, the right rear speaker 138, and the subwoofer 139 may output the audio signal of the left front channel, the audio signal of the right front channel, the audio signal of the center channel, the audio signal of the left rear channel, the audio signal of the right rear channel, and the audio signal of the subwoofer channel, respectively.

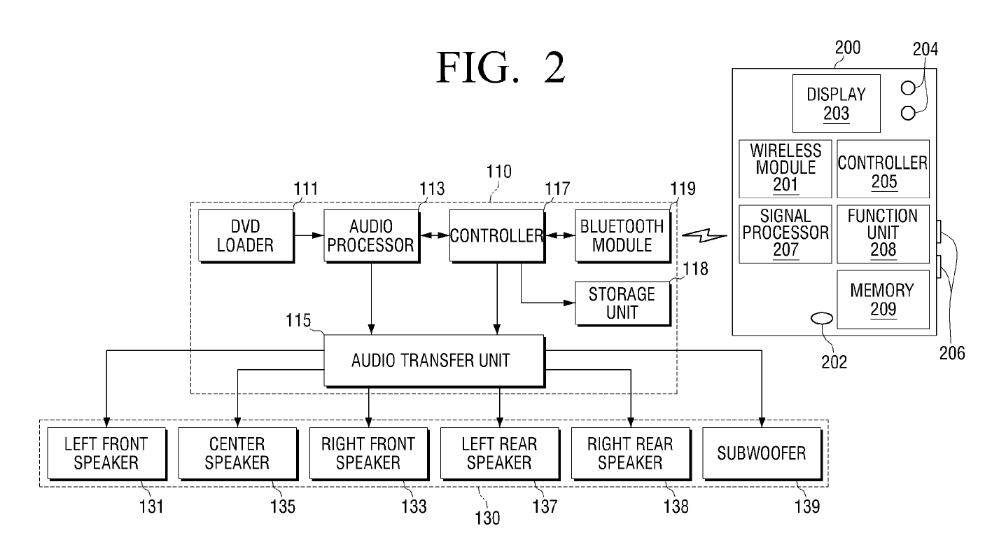

An external apparatus, or portable audio calibration device, 200 illustrated in FIG. 1 may receive a sound output from the sound output unit 130 under the control of the main body 110, and may convert the received sound into an electric signal, for example an audio signal. The external apparatus 200 may then perform predetermined signal processing on the audio signal, to generate a calibration audio signal. Signal processing of the audio signal may include audio compression, for example, to reduce the bandwidth of the signal prior to transmission. The external apparatus 200 may then transmit the compressed calibration audio signal to the main body 110 wirelessly. A mutual operation between the audio system 100 and the external apparatus 200 will be described later with reference to FIG. 2.

The external apparatus 200 may be a portable apparatus equipped with a Bluetooth module and a microphone. The external apparatus 200 may be an electronic device, for example, a notebook computer, an MPEG audio layer-3 (MP3) player, a mobile phone, a digital multimedia broadcasting (DMB) phone, a digital camera, or a camcorder. The Bluetooth module and microphone may be detachably mounted to the external apparatus 200, and the external apparatus 200 may further include an ear jack. The main body may have a corresponding element to communicate with the Bluetooth module of external apparatus 200.

FIG. 2 illustrates a block diagram of the main body 110 of the audio system 100 illustrated in FIG. 1. For convenience of description, the sound output unit 130 and the external apparatus 200 are also illustrated in FIG. 2.

The main body 110 causes sounds corresponding to audio signals stored in a recording medium, such as a digital versatile disc (DVD), to be output through each of the six speakers of the sound output unit 130, and receives the compressed calibration audio signal from the external apparatus 200 through Bluetooth communication. The calibration audio signal may be used to calibrate audio signals to be played back received from the recording medium, a transmission medium, a broadcast station, or a service provider.

The recording medium of the present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains. A computer-readable transmission medium may be, for example, a module having a wireless transceiver.

The main body 110 may include a DVD loader 111, an audio processor 113, an audio transfer unit 115, a controller 117, a storage unit 118, and a wireless communication module, such as a Bluetooth module 119.

The DVD loader 111 may read an audio signal compressed in an MPEG-2 format or other format from a recording medium such as a DVD.

The DVD loader 111 then transmits the read audio signal to the audio processor 113.

The audio processor 113 may perform signal processing on the compressed audio signal output from the DVD loader 111 and a compressed calibration audio signal received via the Bluetooth module 119 from the external apparatus 200, and then may output decompressed 5.1 channel audio signals. The compressed audio signal read by the DVD loader 111 refers to an audio signal to be played back, and the compressed calibration audio signal received via the Bluetooth module 119 from the external apparatus 200 refers to a calibration audio signal.

In more detail, the audio processor 113 decodes the compressed audio signal output from the DVD loader 111, and the compressed calibration audio signal which is received via the Bluetooth module 119 from the external apparatus 200 under the control of the controller 117. For example, a smart bitrate control (SBC) codec may be used to decode the calibration audio signal.

The audio transfer unit 115 may convert an audio signal which is output from the audio processor 113 to be played back and a calibration audio signal which is output from the controller 117 into audio signals with formats capable of being output through the sound output unit 130. The audio signal to be played back refers to an audio signal decoded by the audio processor 113.

More specifically, the audio transfer unit 115 may convert the audio signals decoded by the audio processor 113 into pulse width modulation (PWM) signals using a PWM integrated circuit (IC), and may switch the converted PWM signals to individually extract an audio signal of the left front channel, an audio signal of the right front channel, an audio signal of the center channel, an audio signal of the left rear channel, an audio signal of the right rear channel, and an audio signal of the subwoofer channel.

Additionally, the audio transfer unit 115 may transfer each of the extracted audio signals to the left front speaker 131, the right front speaker 133, the center speaker 135, the left rear speaker 137, the right rear speaker 138, and the subwoofer 139, respectively, via wires. The main unit 110 may have terminals T1-T6 to connect the wires to the main unit 110 and the respective speakers.

In more detail, after extraction of the audio signals, the audio signal of the left front channel, the audio signal of the right front channel, the audio signal of the center channel, the audio signal of the left rear channel, the audio signal of the right rear channel, and the audio signal of the subwoofer channel may be transferred by the audio transfer unit 115 to the left front speaker 131, the right front speaker 133, the center speaker 135, the left rear speaker 137, the right rear speaker 138, and the subwoofer 139, respectively.

The sound output unit 130 converts each of the audio signals received from the audio transfer unit 115 into sounds, and outputs the converted sounds.

In more detail, the sound output unit 130 converts the audio signal of the left front channel, the audio signal of the right front channel, the audio signal of the center channel, the audio signal of the left rear channel, the audio signal of the right rear channel, and the audio signal of the subwoofer channel into sounds corresponding to the audio signals for each channel, and outputs the converted sounds through the left front speaker 131, the right front speaker 133, the center speaker 135, the left rear speaker 137, the right rear speaker 138, and the subwoofer 139, respectively.

The controller 117 controls the audio transfer unit 115 to transfer audio signals which are processed by the audio processor 113 to be played back, and test audio signals to the sound output unit 130. The test audio signals may be previously set in order to calibrate the audio signals to be played back.

In response to a signal calibration command, the controller 117 controls the audio transfer unit 115 to transfer the test audio signals to the sound output unit 130. In this situation, the signal calibration command may be received by a user using a manipulator (not illustrated) included in the main body 110 or a manipulator 203 included in the external apparatus 200. A manipulator may include, for example, a button, a knob, a switch, a touch-screen, or a voice-activated command.

More specifically, after receiving the signal calibration command, the controller 117 may control the audio transfer unit 115 to transfer six channel test audio signals corresponding to frequencies within a preset frequency band to the six speakers of the sound output unit 130, respectively, while sweeping through the preset frequency band. The sound output unit 130 converts the six channel test audio signals received through the audio transfer unit 115 into sounds and outputs the converted sounds. In other words, each of the six channel test audio signals may be output through each of the six speakers of the sound output unit 130.

The frequencies of the six channel test audio signals output respectively through the six speakers may be configured so that they do not overlap one another. The six channel test audio signals may be preset to be transferred to each of the six speakers in the preset frequency band during a preset time period.

Additionally, the frequency band may be previously set to be in the range of about 200 Hz to 20 KHz. Moreover, the time period may be previously set to be in the range of 10 msec to 20 msec, so that it sounds to a user as though the sounds corresponding to the six channel test audio signals are simultaneously output from the six speakers.

In response to a connection request message received from the external apparatus 200, the controller 117 may initiate wireless communication, e.g. Bluetooth communication, between the audio system 100 and the external apparatus 200 via the Bluetooth module 119 in the main unit 110 and the Bluetooth module 201 within or in communication with the external apparatus 200. In more detail, after receiving the connection request message from the external apparatus 200, the controller 117 commands the Bluetooth module 119 to send an acknowledge message ACK in response to the connection request message to the external apparatus 200, so that Bluetooth communication is established between the main unit 110 and the external apparatus 200.

The controller 117 may transfer the compressed calibration audio signal received via the Bluetooth module 119 from the external apparatus 200 to the audio processor 113, receive the decompressed calibration audio signal from the audio processor 113, and filter frequencies of the received calibration audio signal, to divide the calibration audio signal for each of the six channels.

The calibration audio signal may include a number of calibration audio signals to correspond to the audio signals of the respective channels and may be divided into components to correspond to respective channels.

The controller 117 may compare the time interval, phase, and frequency level of the divided calibration audio signals to those of the six channel test audio signals output from the audio transfer unit 115, and may store difference values obtained by the comparing operation as signal calibration values in the storage unit 118. The frequency level may refer to the volume, and the storage unit 118 may store a first signal calibration value to sixth signal calibration value which respectively correspond to the six channels.

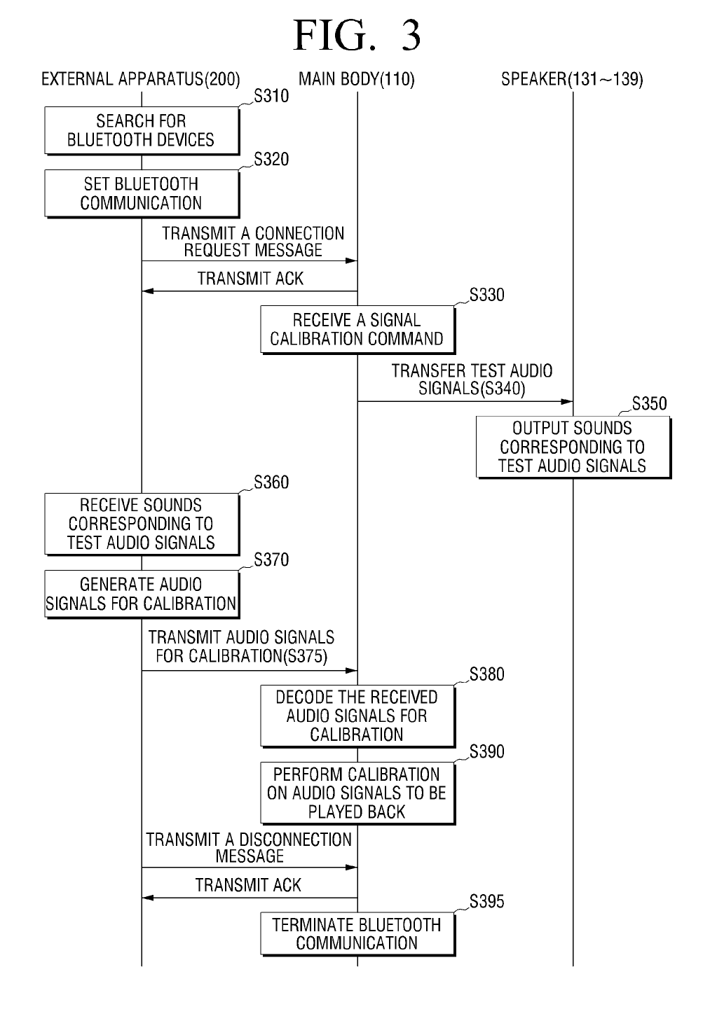

The controller 117 may perform signal calibration on the audio signal to be played back, based on the first to sixth signal calibration values stored in the storage unit 118, and may control the audio transfer unit 115 and sound output unit 130 so that a sound corresponding to the calibrated audio signal is played back. For example, the audio signals output from the recording medium may be changed or adjusted according to the one or more signal calibration values in time interval, phase, and frequency levels thereof. Also, the audio signals of the respective channels can be adjusted according to corresponding signal calibration values. This process will be described in detail with reference to FIG. 3.

After the first to sixth signal calibration values are stored and signal calibration is completed, the controller 117 may display a calibration completion message and the first to sixth signal calibration values on an external display apparatus (not illustrated). The calibration completion message and the first to sixth signal calibration values may be displayed on a display unit of the external apparatus 200 through Bluetooth communication, for example.

In more detail, in response to a disconnection message received from the external apparatus 200, the controller 117 terminates Bluetooth communication with the external apparatus 200. A user may enter the disconnection message using a manipulator 204 included in the external apparatus 200, so that the disconnection message may be transmitted to the controller 117.

After signal calibration is completed, the controller 117 may display the calibration completion message and the first to sixth signal calibration values on an external display apparatus (not illustrated) or on the external apparatus 200. Additionally, if a predetermined time elapses after displaying the calibration completion message and the first to sixth signal calibration values, the communication between the audio system 100 and the external apparatus 200 may automatically terminate without any user operation.

The external apparatus 200 may include an integral wireless module 201 as a transceiver, such as a Bluetooth module, or may be connected to an external wireless module. The external apparatus may further include a microphone 202 for receiving audible sounds, a display 203 to display data that may include calibration data, manipulators 204, such as buttons, keys, or switches, and a function unit 208 to perform voice, image, video, data entry, or other functions of the device. For example, if the external device is a laptop, the function unit 208 may control the interfacing, data entry, and display functions of the laptop. The calibration data displayed on the display 203 may include information regarding the status of calibration, sound levels, microphone input levels, or signal levels, or may include prompts to generate user responses, for example.

The external apparatus 200 may also have a controller 205 to control the wireless module 201, microphone 202, display 203, manipulators 204, and function unit 208. The controller 205 may also include a signal processor or be connected to a signal processor 207 to process signals from the microphone 202 and to output signals via the wireless module 201. For example, the processor may compress calibration audio signals received from the microphone to generate compressed calibration signals to send to the wireless module 201. The external apparatus 200 may include external terminals 206 including power terminals, ear jacks, auxiliary input/output terminals, or other terminals. The external apparatus may also include memory 209 to store data from any of the above portions of the external apparatus 200.

FIG. 3 illustrates a flowchart explaining an operating method of the audio system 100 according to an exemplary embodiment of the present general inventive concept.

The external apparatus 200 may search for Bluetooth or other wireless devices positioned near the external apparatus 200 in operation S310.

For example, if a user enters a command to search for Bluetooth devices using the manipulator of the external apparatus 200, the external apparatus 200 may search for Bluetooth devices within a preset range from the position of the external apparatus 200, and may display available Bluetooth devices found as a result of searching on a display unit 203 of the external apparatus 200.

Subsequently, the external apparatus 200 may initiate Bluetooth communication with the main unit 110 selected by the user from among the available Bluetooth devices displayed on the display unit in operation S320.

More specifically, the external apparatus 200 may transmit to the main unit 110 the connection request message to request communication connection, and may receive the acknowledge message ACK in response to the connection request message from the main unit 110, so that Bluetooth communication is established between the main unit 110 and the external apparatus 200.

When the signal calibration command is received in operation S330, the controller 117 sweeps through the preset frequency band during a preset time period and controls the six channel test audio signals to be transferred to each of the six speakers of the sound output unit 130 in operation S340.

For example, the frequency band may be previously set to be in the range of about 200 Hz to 20 KHz, and sounds corresponding to the test audio signals may be output from the six speakers every 10 msec to 20 msec. Additionally, the signal calibration command may be received by a user using a manipulator (not illustrated) included on the main body 110 or a manipulator 204 included on the external apparatus 200.

In operation S340, if the user enters the signal calibration command using the manipulator (not illustrated) included in the main body 110 or the manipulator 204 included on the external apparatus 200, the controller 117 commands the audio transfer unit 115 to transfer the six channel test audio signals corresponding to frequencies within the preset frequency band to each of the six speakers of the sound output unit 130, while sweeping through the preset frequency band.

The sound output unit 130 outputs the sounds corresponding to the test audio signals received through the audio transfer unit 115 in operation S350. In other words, the sounds corresponding to the six channel test audio signals received through the audio transfer unit 115 may be output from the six speakers of the sound output unit 130.

The controller 117 controls the audio transfer unit 115 and the sound output unit 130 so that it sounds to a user as though each of the sounds corresponding to the six channel test audio signals are simultaneously output through each of the six speakers.

Subsequently, in operation S360 the external apparatus 200 receives the sounds corresponding to the six channel test audio signals output from the six speakers.

The external apparatus 200 then converts the received sounds into electric signals in operation S370 to generate calibration audio signals, and encodes the calibration audio signals, such as by compressing the calibration audio signals.

During operation S360, after the sounds corresponding to the test audio signals output from the six speakers are received via a microphone 202 included in the external apparatus 200, the external apparatus 200 converts the received sounds into electric signals to generate calibration audio signals. Then, the external apparatus 200 may encode the calibration audio signals using the SBC codec, for example.

Next, in operation S375, the external apparatus 200 transmits the calibration audio signals compressed using the SBC codec to the audio system 100 through Bluetooth communication.

The audio system 100 receives the calibration audio signals from the external apparatus 200, and decodes the received calibration audio signal in operation S380.

During operation S380, the audio processor 113 decodes the compressed calibration audio signals received via the Bluetooth module 119 from the external apparatus 200 using the SBC codec, and transfers the decoded calibration audio signals to the controller 117.

The controller 117 compares the time interval, phase, and frequency level of the decoded calibration audio signals to those of the six channel test audio signals transferred to the sound output unit 130 at operation S340, computes signal calibration values for each difference in time interval, phase, and frequency level, and stores the computed signal calibration values.

The audio system 100 performs calibration on audio signals to be played back received from the recording medium or transmission medium based on the stored signal calibration values when outputting these audio signals in operation S390.

The controller 117 may perform signal calibration on the audio signals to be played back which are read by the DVD loader 111 and decoded by the audio processor 113, based on the signal calibration values stored in the storage unit 118, and may control the audio transfer unit 115 to transfer the calibrated audio signals to each of the six speakers. Accordingly, sounds corresponding to the calibrated audio signals may be output from the six speakers.

The signal calibration values may be stored in each of the six speakers. For example, if a signal calibration value for a frequency level of the center speaker 135 is set to be about 20 Hz, the controller 117 may increase a frequency of an audio signal to be played back, which is read by the DVD loader 111 and decoded by the audio processor 113, to about 20 Hz, and may control the audio transfer unit 115 and sound output unit 130 so that a sound corresponding to the audio signal having a frequency increased to about 20 Hz may be output from the center speaker 135.

Similarly, the controller 117 may compensate time intervals of audio signals for playback which are read by the DVD loader 111 and decoded by the audio processor 113 based on signal calibration values for time interval stored in each of the six speakers, and may control the audio transfer unit 115 to transfer to each of the six speakers of the sound output unit 130 the audio signals having time intervals that are compensated.

Subsequently, the audio system 100 may terminate Bluetooth communication with the external apparatus 200 in operation S395.

During operation S395, the controller 117 may display each of the signal calibration values set to each of the corresponding six speakers on an external display apparatus (not illustrated). When the disconnection message is received from the external apparatus 200, the controller 117 may transmit the acknowledge message ACK in response to the disconnection message to the external apparatus 200, and may terminate Bluetooth communication with the external apparatus 200. For example, the user may enter the disconnection message using a manipulator 204 included in the external apparatus 200, so that the disconnection message may be transmitted to the controller 117.

Alternatively, if a predetermined time elapses after displaying each of the signal calibration values set to each of the corresponding six speakers on an external display apparatus (not illustrated) or the external apparatus 200, the controller 117 may terminate Bluetooth communication with the external apparatus 200. In other words, the Bluetooth communication between the controller 117 and the external apparatus 200 may automatically terminate without any user operation.

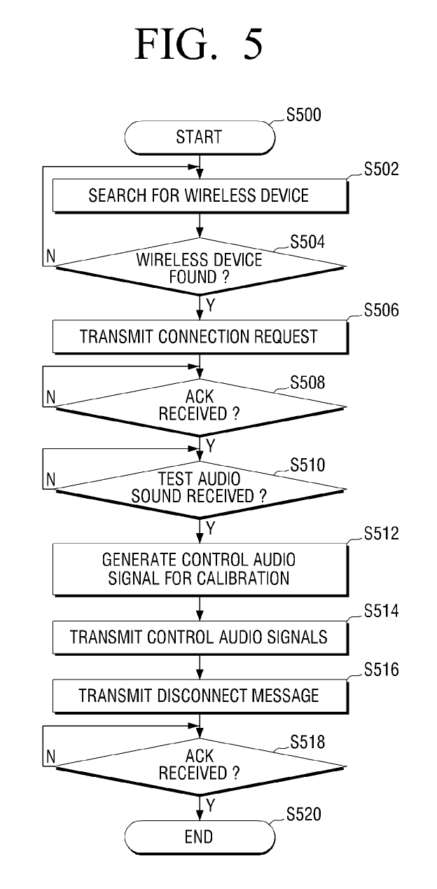

Referring to FIG. 5, a calibration method for the external apparatus 200 is shown. The calibration may begin (S500) automatically or as a result of user input at either the main unit 110 or the external apparatus 200. The external apparatus 200 may search for a wireless device such as a Bluetooth-enabled device (S502). Upon detecting the Bluetooth-enabled device (S504), such as main unit 110, the external apparatus 200 may transmit a connection request (S506) to the main unit 110. The external apparatus may wait to receive an acknowledgement (ACK) (S508) and then may wait to receive test audio sounds from the audio output device 130 (S510). The external apparatus 200 may generate calibration audio signals to calibrate the main unit 110 (S512) and may transmit the calibration audio signals to the main unit (S514). The calibration audio signals may be compressed audio signals, for example. The external apparatus 200 may transmit a disconnect message (S516) and end the calibration process when an acknowledge signal (ACK) is received from the main unit 110 (S518, S520).

The external device may perform any of the above processes repeatedly as necessary to properly calibrate the audio system 100. For example, as shown in FIG. 5, the external apparatus may await additional test audio sounds if the main unit 110 fails to acknowledge a disconnect message within a certain period of time or if the main unit 110 rejects a disconnect message. The external device may also automatically repeat the process of awaiting test audio sounds and sending calibration audio signals until a “calibration complete” signal is received from main unit 110.

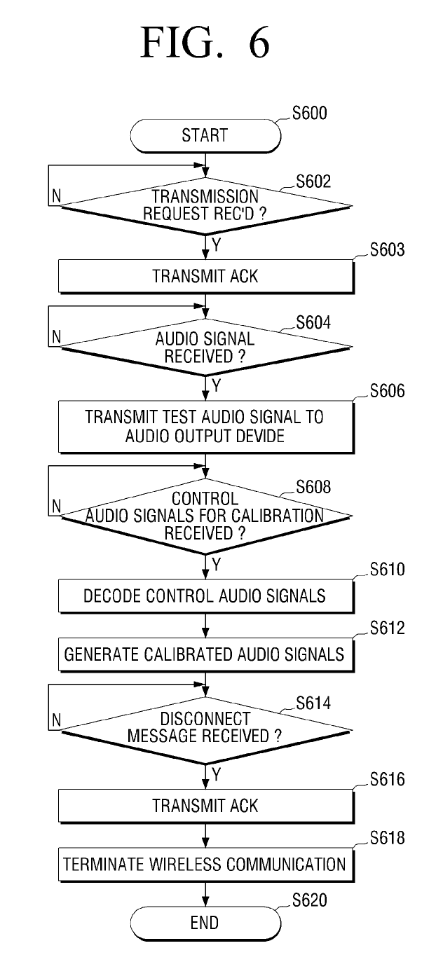

Referring to FIG. 6, a calibration method for the main unit 110 is shown. The process begins (S600), and upon receiving a transmission request from an external apparatus 200 (S602), the main unit 110 may transmit an acknowledge signal ACK (S603). The main unit 110 may receive an audio signal (S604), from a recording medium or transmission medium, for example, and may transfer a test audio signal to an audio output device 130 (S606). The main unit 110 may then wait to receive calibration audio signals via its Bluetooth module 119 or other wireless module. The main unit 110 may decode the calibration audio signals (S610) and output calibrated audio signals (S612). Upon receiving a disconnect message from the external apparatus 200 (S614), the main unit may transmit an acknowledgement ACK (S616) and terminate the wireless communication with the external apparatus (S618), ending the calibration process (S620).

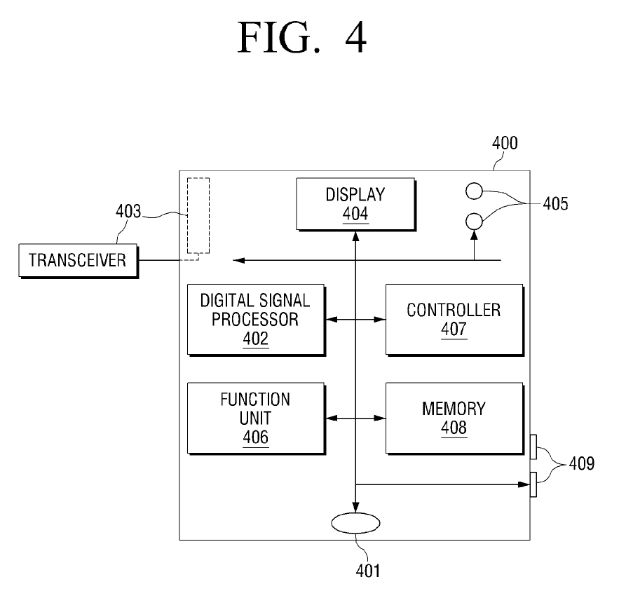

Referring to FIG. 4, an example of an external apparatus or device 400 is shown, corresponding to the external apparatus 200 of FIG. 2. The external apparatus may be a portable device, such as a handheld device, laptop, or other device having a microphone 401 to receive audible sounds and connected to a wireless transceiver 403 to transmit electrical signals to the main unit 110. As shown in FIG. 4, the transceiver 403 may be incorporated within the external apparatus 400 or it may be connected to the external apparatus 400. The transceiver may be a Bluetooth module, for example. The transceiver may also receive electrical signals from the main unit 110. Audible sounds received by the microphone 401 may be converted into a calibration audio signal by a digital signal processor 402. The digital signal processor 402 may then transmit the calibration audio signal to the transceiver 403. The digital signal processor 402 may encode the calibration audio signal, such as by compression, before transmitting.

The external apparatus 400 may have a display 404 for displaying connection, calibration, or termination data. The calibration data displayed on the display 404 may include information regarding the status of calibration, sound levels, microphone input levels, or signal levels, or may include prompts to generate user responses. For example, a user may use manipulators 405 to search for a wireless device, such as a Bluetooth-enabled device, and to connect to main unit 110. The main unit 110 may send data to the external device 400 prompting the user to initiate calibration, and the main unit 110 may then send data to the external device representing the progress of the calibration. When the calibration is terminated, the main unit 110 may send data to the external device 400 indicating whether calibration was successful, whether it was terminated manually or automatically, or whether any errors occurred.

The external apparatus may also have a functional unit 406 to control voice, image, video, data entry, or other functions of the device. For example, if the external device is a laptop, the function unit 406 may control the interfacing, data entry, and display functions of the laptop.

The external apparatus 400 may also have a controller 407 to control the transceiver 403, microphone 401, digital signal processor 402, display 404, manipulators 405, and function unit 406. The external apparatus 400 may include external terminals 409 including power terminals, ear jacks, auxiliary input/output terminals, or other terminals. The external apparatus may also include memory 408 to store data from any of the above portions of the external apparatus 400.

The main unit 110 may transmit data to the external apparatus 400 via transceiver 403. For example, the main unit 110 may transmit data to display information regarding the progress of the audio calibration, including connection, initiation, testing, and termination of the calibration. Manipulators 405 may be located on the external device to initiate or terminate calibration, select calibration options, or respond to main unit 110 requests, for example.

While an audio system according to the present general inventive concept reads a compressed audio file, such as an MPEG-2 compressed audio file, and outputs a sound corresponding to the read audio file, the present general inventive concept is not limited to such an audio file. According to the present general inventive concept, it may be possible to output sounds corresponding to a non-compressed audio interchange file format (AIFF) audio file, a non-compressed waveform (WAV) audio file, a musical instrumental digital interface (MIDI) audio file, and an MPEG-1 compressed audio file, for example, via speakers.

Additionally, the left front speaker 131, the right front speaker 133, the center speaker 135, the left rear speaker 137, the right rear speaker 138, and the subwoofer 139 of the sound output unit 130 are separated from the main body 110 in the exemplary embodiment of the present general inventive concept, but this is merely an example for convenience of description. Accordingly, the present general inventive concept is also applicable to a situation in which the main body 110 includes part or all of the six speakers of the sound output unit 130.

Furthermore, the audio system 100 controls 5.1 channel audio signals to be output from the six speakers of the sound output unit 130 in the exemplary embodiment of the present general inventive concept, but this is merely an example for convenience of description. For example, a 6.1 channel audio signal, 7.1 channel audio signal, or other audio signal may also be output from the six speakers of the sound output unit 130.

Moreover, the main unit 110 transmits audio signals to the six speakers of the sound output unit 130 via a wire in the exemplary embodiment of the present general inventive concept, but this is merely an example for convenience of description. Accordingly, the main unit 110 may wirelessly transmit audio signals to all of the six speakers, or may transmit audio signals to one of the six speakers wirelessly and transmit audio signals to another of the six speakers via a wire.

Additionally, a Bluetooth module is used as a transceiver to transmit or receive audio signals between an audio system and an external apparatus in the exemplary embodiment of the present general inventive concept, but this is merely an example for convenience of description. Accordingly, the present general inventive concept is equally applicable to any module capable of performing wireless communication as a transceiver.

While each audio signal corresponding to each of the six speakers of the sound output unit 130 is output through each of the six speakers in the exemplary embodiment of the present general inventive concept, this is merely an example for convenience of description. Each of the six speakers of the sound output unit 130 may simultaneously output at least one of the audio signal of the center channel, the audio signal of the left front channel, the audio signal of the right front channel, the audio signal of the left rear channel, the audio signal of the right rear channel, and the audio signal of the subwoofer channel.

According to the present general inventive concept as described above, it is possible to perform calibration on an audio signal to be played back based on a calibration audio signal which is received wirelessly via a Bluetooth module. Therefore, it is possible to avoid user inconvenience of having to manipulate a wire microphone, and to reduce costs of the wire microphone.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An audio apparatus comprising:
a sound output unit to output a sound corresponding to a received audio signal;
a transceiver connected to an external apparatus the external apparatus to convert the sound output from the sound output unit into a calibration audio signal, the transceiver enabling wireless communication between the sound output unit and the external apparatus; and
a controller to perform calibration on an audio signal to be played back through the sound output unit.

2. The audio apparatus of claim 1, wherein:
the controller transfers a test audio signal to the sound output unit and controls the sound output unit to output a sound corresponding to the test audio signal; and
the external apparatus converts the sound, which corresponds to the test audio signal and is output from the sound output unit, into an electric signal to generate the calibration audio signal.

3. The audio apparatus of claim 1, wherein the external apparatus comprises a portable apparatus with a microphone to receive the sound corresponding to the test audio signal.

4. The audio apparatus of claim 3, wherein the external apparatus comprises at least one of a notebook computer, an MPEG audio layer-3 (MP3) player, a mobile phone, a digital multimedia broadcasting (DMB) phone, a digital camera, and a camcorder.

5. The audio apparatus of claim 1, further comprising:
an audio transfer unit to transfer a plurality of test audio signals,
wherein the controller controls the audio transfer unit to transfer a plurality of test audio signals corresponding to a plurality of frequency signals in a preset frequency band to the sound output unit during a preset time period.

6. The audio apparatus of claim 5, wherein the controller controls the audio transfer unit to continue to transfer the plurality of test audio signals to the sound output unit during the preset time period so that the plurality of frequency signals do not overlap.

7. The audio apparatus of claim 5, wherein:
the sound output unit comprises a plurality of speakers; and
the preset time period is set so that a plurality of sounds corresponding to the plurality of test audio signals are output through the plurality of speakers at the same time.

8. The audio apparatus of claim 6, wherein the controller controls the audio transfer unit to transfer each of the plurality of test audio signals to each of the plurality of speakers while sweeping through the frequency band.

9. The audio apparatus of claim 5, wherein:
the frequency band is preset to be in the range of about 200 Hz to 20 KHz; and
the controller controls the audio transfer unit to transfer each of the plurality of test audio signals to each of the plurality of speakers while sweeping through the frequency band.

10. The audio apparatus of claim 1, wherein the controller displays a calibration completion message on an external display apparatus stating that calibration of the audio signal to be played back is completed when calibration of the audio signal to be played back through the sound output unit is completed using the calibration audio signal,.

11. The audio apparatus of claim 1, wherein the controller calibrates at least one of a phase, a time interval, and a signal level of the audio signal to be played back based on the calibration audio signal, and controls the sound output unit to output a sound corresponding to the audio signal of which at least one of the phase, the time interval, and the signal level is calibrated.

12. A signal calibration method comprising:
wirelessly receiving a calibration audio signal generated by converting an output sound into an electric signal; and
using the received calibration audio signal to calibrate an audio signal to be played back.

13. The signal calibration method of claim 12, further comprising:
outputting a plurality of sounds corresponding to a plurality of test audio signals,
wherein the calibration audio signal is generated by converting the plurality of sounds corresponding to the plurality of test audio signals into a plurality of electric signals.

14. The signal calibration method of claim 13, wherein:
the plurality of test audio signals correspond to a plurality of frequency signals in a preset frequency band during a preset time period; and
outputting the plurality of sounds comprises outputting a plurality of sounds corresponding to the plurality of test audio signals.

15. The signal calibration method of claim 14, wherein outputting the plurality of sounds comprises continuously outputting the plurality of test audio signals during the preset time period so that the plurality of frequency signals do not overlap.

16. The signal calibration method of claim 14, wherein the preset time period is set so that a listener feels as if the plurality of sounds corresponding to the plurality of test audio signals are output from a plurality of channels at the same time.

17. The signal calibration method of claim 14, wherein outputting the plurality of sounds comprises outputting the plurality of sounds corresponding to the plurality of test audio signals to each of the plurality of channels while sweeping through the frequency band.

18. The signal calibration method of claim 14, wherein:
the frequency band is preset to be in the range of about 200 Hz to 20 KHz; and
outputting the plurality of sounds comprises outputting the plurality of sounds corresponding to the plurality of test audio signals to each of the plurality of channels while sweeping through the frequency band.

19. The signal calibration method of claim 12, wherein calibrating the audio signal to be played back comprises displaying a calibration completion message on an external display apparatus stating that calibration of the audio signal to be played back is completed when calibration of the audio signal to be played back is completed using the calibration audio signal,.

20. The signal calibration method of claim 12, wherein calibrating the audio signal to be played back comprises calibrating at least one of a phase, a time interval, and a signal level of the audio signal to be played back based on the calibration audio signal.

21. A portable device to receive a sound and wirelessly output a calibration signal, comprising:
a microphone to receive a sound;
a signal processor to process a calibration signal from the microphone corresponding to the sound; and
a transceiver to wirelessly transmit the calibration audio signal.

22. The portable device according to claim 21, wherein the transceiver is externally connected to the portable device.

23. The portable device according to claim 21, further comprising:
a manipulator to receive user input, and
a display to display data received via the transceiver.

24. The portable device according to claim 23, further comprising:
memory to store data from at least one of the microphone, the manipulator, and the signal processor;
a function unit to control non-calibration functions of the portable device; and
a controller to control at least one of the microphone, signal processor, transceiver, manipulator, display, memory, and function unit.

25. The portable device according to claim 21, wherein the portable device is one of an mp3 player, a laptop, a video camera, and a telephone.

26. A main unit of an audio system, the main unit comprising:
a controller to receive a first audio signal and to receive a calibration audio signal corresponding to a sound produced using the first audio signal, the controller to calibrate a second audio signal using the calibration audio signal to generate a calibrated audio signal;
a transceiver to wirelessly receive the calibration audio signal; and
terminals to output the first audio signal and the calibrated audio signal.

27. The main unit of an audio system according to claim 26, wherein the transceiver is a Bluetooth-capable transceiver.

28. The main unit of an audio system according to claim 26, further comprising:
a recording medium receiver to receive a recording medium and output at least one of the first and second audio signals;
an audio processor to receive the first and second audio signals and the calibration audio signal, to process the signals, and to output the processed signals to the controller; and
an audio transfer unit to receive the processed first, second, and calibrated audio signals from the controller and to output respective first, second, and calibrated audio output signals to the terminals.

29. The main unit of an audio system according to claim 28, wherein the first, second, and calibration audio signals are compressed audio signals, and the audio processor is to decompress the first, second, and calibration audio signals.

30. The main unit of an audio system according to claim 26, further comprising a display for displaying data in response to at least one of receiving the first audio signal, receiving the calibration audio signal, and outputting the calibrated audio signal.

31. An audio system, comprising:
a main unit, comprising:
a controller to receive a first audio signal and to receive a calibration audio signal corresponding to a sound produced using the first audio signal, the controller to calibrate a second audio signal using the calibration audio signal to generate a calibrated audio signal,
a first transceiver to wirelessly receive the calibration audio signal, and
terminals to output the first audio signal and the calibrated audio signal; and
a portable calibration device, comprising:
a microphone to receive a sound corresponding to the first audio signal,
a signal processor to process a calibration audio signal from the microphone corresponding to the sound, and
a second transceiver to wirelessly transmit the calibration audio signal to the main unit.

32. The audio system according to claim 31, further comprising at least one sound output unit connected to the terminals of the main unit to output sound.

33. The audio system according to claim 32, wherein the sound output units are speakers.

34. An audio signal calibration method for a portable calibration device, comprising:
wirelessly outputting a connection request;
receiving a connection acknowledgement;
receiving a test sound via a microphone;
converting the test sound into a calibration audio signal; and
wirelessly outputting the calibration audio signal.

35. The method according to claim 34, wherein receiving a test sound, converting the test sound into a calibration audio signal, and wirelessly outputting the calibration audio signal are repeated until a termination signal is wirelessly received.

36. The method according to claim 34, further comprising wirelessly transmitting a disconnect message after outputting the calibration audio signal.

37. The method according to claim 34, further comprising digitally compressing the calibration audio signal before wirelessly outputting the calibration audio signal.

38. The method according to claim 34, wherein the calibration audio signal is wirelessly output via a Bluetooth module.

39. An audio signal calibration method for a main unit of an audio system, the method comprising:
wirelessly receiving a transmission request from an external device;
wirelessly transmitting a transmission acknowledgement;
outputting a first audio signal;
receiving a calibration audio signal corresponding to a sound generated from the first audio signal;
calibrating a second audio signal using the calibration audio signal to generate a calibrated audio signal to generate a calibrated audio signal; and
outputting the calibrated audio signal corresponding to the second audio signal.

40. The method according to claim 39, further comprising decompressing the first audio signal and the calibration audio signal.

41. The method according to claim 39, wherein the transmission request and the calibration audio signal are received via a Bluetooth module.

42. The method according to claim 39, wherein the first audio signal is received from a recording medium.

43. The method according to claim 42, wherein the recording medium is one of a DVD, a cassette, a compact disk, a floppy disk, and a hard drive.

44. The method according to claim 39, wherein calibrating the second audio signal comprises calibrating at least one of a phase, a time interval, and a signal level of the second audio signal.

45. An audio signal calibration method, comprising:
transmitting a first audio signal from a main unit to a sound output device;
receiving a first sound corresponding to the first audio signal with an external device comprising a microphone, the external device not being connected to the main unit via wires;
converting the first sound into a calibration audio signal with the external device;
wirelessly transmitting the calibration audio signal from the external device to the main unit;
generating a calibrated audio signal with the main unit using a second audio signal and the calibration audio signal; and
outputting the calibrated audio signal to the sound output device.

46. The audio signal calibration method according to claim 45, further comprising wirelessly transmitting calibration data from the main unit to the external device and displaying the calibration data on the external device.

47. The method according to claim 45, further comprising displaying calibration data on a display connected to the main unit.

48. The method according to claim 45, further comprising:
digitally compressing the calibration audio signal with the external device; and
digitally decompressing the calibration audio signal with the main unit.
